(19) United States
(12) Patent Application Publication
(10) Pub. No.: US 2013/0005811 A1
(43) Pub. Date: Jan. 3, 2013

(54) ANTIMICROBIAL TREATMENT FOR SEEDS AND SPROUTS

(76) Inventors: Ronald Walcott, Athens, GA (US); Michael Doyle, Peachtree City, GA (US); Tong Zhao, Peachtree City, GA (US)

(21) Appl. No.: 13/510,724

(22) PCT Filed: Mar. 9, 2011
(86) PCT No.: PCT/US11/27719

§ 371 Date: May 18, 2012

Related U.S. Application Data
(60) Provisional application No. 61/316,582, filed on Mar. 23, 2010.

(51) Int. Cl. A01N 37/12; A01P 1/00

(52) U.S. Cl. 514/557

(57) ABSTRACT

The present disclosure encompasses embodiments of a method of reducing the microbial load of a vegetable seed or a sprout thereof, comprising contacting the vegetable seed or the sprout thereof, with a composition comprising levulinic acid and a detergent for a period suitable for reducing a bacterial population of the vegetable seed or the sprout thereof. In embodiments of the methods of the disclosure, the composition can reduce a bacterial population located on the exterior surface of the seed coat (testa) of a vegetable seed, located in or on the seed contents beneath the testa, or located on and beneath the testa of the vegetable seed.

### CROSS-REFERENCE TO RELATED APPLICATIONS

This application claims priority to U.S. Provisional Patent Application Ser. No. 61/314,922, entitled “TREATMENT FOR ALFALFA SEEDS AND SPROUTS” filed on Mar. 17, 2010, and to U.S. Provisional Patent Application Ser. No. 61/316,582 entitled “EFFICACY OF A NOVEL ANTIMICROBIAL SOLUTION AGAINST PHYTOPATHOGENIC BACTERIA, AND FEASIBILITY AS A VEGETABLE SEED TREATMENT” filed on Mar. 23, 2010, the entireties of which are hereby incorporated by reference.

### TECHNICAL FIELD

The present disclosure is generally related to compositions and methods of use thereof for reducing the microbial load of plant seeds and sprouts.

### BACKGROUND

U.S. vegetable production has increased significantly in the past ten years and in most cases, vegetables are produced through planting seeds. Vegetable seeds are high value, internationally traded commodities. In 2007 the global vegetable seed trade was estimated at greater than $4 billion USD. However, plant pathogens, and in particular plant pathogenic bacteria, threaten vegetable seed production.

During seed production, plants may become infected with phytopathogenic bacteria that may eventually contaminate the seeds. The mechanisms by which seeds can become infested by bacteria vary significantly based on the plant species and how the seeds are produced. Similarly, the location of the bacterium in the seed may also vary. For example, bacteria may be on the seed coat, but it is also possible for the bacteria to reside deep within the seed. The location of the bacterium in or on the seeds significantly influences the likelihood of successful seed treatments. Infested seeds are virtually indistinguishable from non-infested seeds, and as a result it is difficult to physically segregate them. In general, plant pathogenic bacteria will not negatively affect seed qualities like storability, germination or vigor; however, once planted, infested seeds will give rise to infected seedlings and to diseases affecting the stem, leaves and/or flowers. As the resulting seedlings will be infected early in the plant cycle, the likelihood of a disease outbreak and economic losses is high

On the other hand, infection by phytopathogenic fungi may, in addition to give rise to infected seedlings, also impact the germination potential of seeds, leading to reduced productivity of commercial seed batches. Seed contamination by phytopathogens is a cause of great losses in agriculture. Infection of Cucurbitaceae by, for instance, Acidovorax may be responsible for up to 80% of losses of watermelon crops worldwide. Contamination of grass seeds by fungi (e.g., P. semniperda) and phytoplasma are also associated with losses by affecting either the germination potential of seeds or the appearance and growth of sprouts and leaves.

Besides phytobacterial colonization of seeds and plant crops, microbial populations can include pathogens likely to cause foodborne illnesses. For more than a decade, alfalfa sprouts have been associated with outbreaks of foodborne illness (Safranek et al., (2009) MMWR 58: 1-3). Salmonellosis was associated with consumption of alfalfa sprouts in two large outbreaks in 1994 in Sweden and Finland (Ponka et al., (1995) Lancet 345: 462-463). Salmonella bovismorbificans was the causative agent and the vehicle was Australian alfalfa seeds which had received an antimicrobial treatment of 0.5% sodium hypochlorite for 45 mins. S. bovismorbificans was also isolated from germinated sprouts, but not the seeds. Since 1995, raw and lightly cooked sprouts have been implicated in outbreaks of foodborne illness in the United States, mostly involving alfalfa sprouts, and to a lesser extent cress, mung bean, and clover sprouts. Thirteen Salmonella serotypes were isolated from the clinical cases. Examples include S. Newport associated with alfalfa sprouts (Oregon Health Division (1995) Oregon & BC. Communicable Dis. Summary), S. Stanley from alfalfa sprouts (Mohon et al., (1997) J. Infect. Dis. 175: 876-882), and S. Senftenberg from an alfalfa and clover sprout mixture. Most recently, an S. Saintpaul outbreak, including 228 cases in 13 states, was associated with eating alfalfa sprouts produced at multiple facilities from seeds that likely originated from a common grower (Safranek et al., (2009) MMWR 58: 1-3).

Seeds are generally recognized as sources of sprout-related disease outbreaks and pathogens including Salmonella have been isolated from naturally-contaminated seeds (Inami & Moler (1999) J. Food Prot. 62: 662-664; Mukherjee et al., (2007) Intern. J. Food Microbiol. 120: 296-302; Taormina & Beuchat (1999) J. Food Prot. 62: 850-856). Various treatments, including chlorine-based disinfectants, have been tested to identify disinfection procedures that eliminate pathogens while preserving germinability of the seeds (see, for example: Jaquette et al., (1996) Appl. Environ. Microbiol. 62: 2212-2215; Kumar et al., (2006) J. Food Prot. 69: 1571-1578; Neetoo et al., (2009) Appl. Environ. Microbiol. 75:1901-1905; Proctor (2001) J. Clin. Microbiol. 39: 3461-3465; Rajkowski & Ashurst (2009) Foodborne Pathogens Dis. 6: 1041-1046; Suslow et al., (2002) J. Food Prot. 65: 452-458; Wade et al., (2003) J. Food Prot. 66: 44-51; and Winthrop et al., (2003) J. Food Prot. 66: 13-17).

Taormina & Beuchat ((1999) J. Food Prot. 62: 318-324) determined the efficacy of various chemicals, including calcium hypochlorite, USS-1400 (acidified ClO₂), acidified sodium hypochlorite, sodium chlorite, hydrogen peroxide, ethyl alcohol, trisodium phosphate, TSUNAMI®, VORTEXX® and VEGI-CLEAN® (a citrus-citric-based product) for the elimination of E. coli O157:H7 from alfalfa seeds and their survivability of the pathogen on seeds stored for prolonged periods at different temperatures. The results did not clearly demonstrate that any of these chemicals as individual treatments, or in combination with heat and chemical treatment, would ensure elimination of E. coli O157:H7 from alfalfa seeds.

Rajkowski, K. T. ((2009) J. Food Safety 29:224-235) examined the physical characteristics of different alfalfa seeds after artificial inoculation of pathogens and revealed that cracks or breaks in the seed coats became more pronounced and curled away from the cotyledon; thus bacterial cells in the inocula became trapped in the cracks or under the seed coat during the process. Those bacteria are difficult to reach for inactivation by a sanitizer and extended contact with sanitizer to ensure the inactivation of these bacteria may negatively impact seed physiology.

There is a need, therefore, for an effective seed treatment that can decontaminate vegetable seeds without adversely affecting seed quality or seedling health. Accordingly, many antimicrobial compounds have been evaluated as vegetable seed treatment, including antibiotics such as streptomycin or tetracycline, copper-based compounds, sodium hypochlorite, and peroxyacetic acid. While these treatments do generally reduce the bacterial populations on the seed coat, they usually fail to completely decontaminate the seeds. Hence, in addition to having inherent antimicrobial properties, an effective seed treatment must penetrate the seed coat to make contact with the bacteria under the seed coat, without having a deleterious effect on the seedling physiology, thereby adversely affecting germination or sprout growth.

### SUMMARY

The present disclosure encompasses embodiments of methods of reducing the microbial load of a vegetable seed or a sprout thereof, comprising contacting the vegetable seed or the sprout thereof, with a composition comprising levulinic acid and a detergent for a period suitable for reducing a microbial population of the vegetable seed or the sprout thereof.

In embodiments of the methods of the disclosure, the detergent can be sodium dodecyl sulfate (SDS).

In embodiments of the methods of the disclosure, the concentration of levulinic acid in the composition is between about 0.1% wt/vol and about 5% wt/vol levulinic acid.

In some embodiments of the methods of the disclosure, the concentration of levulinic acid in the composition is about 3% levulinic acid.

In embodiments of the methods of the disclosure, the concentration of SDS in the composition is between about 0.01% wt/vol and about 0.05% wt/vol SDS.

In embodiments of the methods of the disclosure, the concentration of SDS in the composition is about 0.05% SDS.

In one embodiments of the method of the disclosure, the composition comprises about 3% wt/vol levulinic acid and about 0.05% wt/vol SDS.

In embodiments of the methods of the disclosure, the step of contacting the vegetable seed can comprise immersing the vegetable seed or the sprout thereof in the composition.

In embodiments of the methods of the disclosure, the step of contacting the vegetable seed or the sprout thereof, with the composition can comprise contacting the seed with the composition and applying a vacuum thereto, whereby air from the vegetable seed or the sprout thereof, can be replaced with a volume of the composition.

In embodiments of the methods of the disclosure, the composition reduces a bacterial population located on the exterior surface of the seed coat (testa) of a vegetable seed, located in or on the seed contents beneath the testa, or located on and beneath the testa of the vegetable seed.

In some embodiments of the methods of the disclosure, the composition can reduce a microbial population located on the exterior surface of the seed coat (testa) of a vegetable seed, located in or on the seed contents beneath the testa, or located on and beneath the testa of the vegetable seed, wherein the microbial population is a bacterial population.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 is a graph illustrating the effects upon the germination of watermelon seeds of washes having 3% levulinic acid and 0.05% SDS. Seeds were treated by either washing or washing and vacuum-induced impregnation of the seeds. The control was washing the only with 0.05% SDS.

FIG. 2 is a graph illustrating the reduction in microbial colonization of watermelon seeds by Acidovorax avenae subsp. citrulli using 3% levulinic acid and 0.05% SDS applied to the seeds as a wash or as a wash combined with vacuum-induced impregnation.

FIGS. 3A and 3B are a pair of graphs illustrating the effect of 0.5% levulinic acid on in vitro growth of Acidovorax avenae subsp. citrulli (Aac), Pantoea ananatis (PNA), Xanthomonas campestris pv. campestris (XCC), Xanthomonas campestris pv. vesicatoria (XCV) Clavibacter michiganenses subsp. michiganenses (CMM) and Erwinia carotovora subsp. carotovora (ECC). FIG. 3A illustrates the growth curves in nutrient broth of the bacterial species in the absence of levulinic acid. FIG. 3B illustrates the growth curves for the same bacterial species as in FIG. 3A, cultured in the presence of 0.5% levulinic acid.

FIG. 4 is a graph illustrating the effect of seed treatments with 3% levulinic acid and 0.05% SDS on BFB seedling transmission and germination percentages of watermelon seeds naturally infested with A. avenae subsp. citrulli. Seeds were treated by vacuum infiltration or by soaking for 60 mins. Bars represent the means (BFB seedling transmission and germination) and the lines represent standard deviations of the means. Treatments with similar letters are not significantly different according to Fisher's LSD.

FIG. 5 is a graph illustrating the effect of seed treatment with 3% levulinic acid and 0.05% SDS on BFB seedling transmission over time for melon seeds naturally infested with A. avenae subsp. citrulli.

FIG. 6 is a graph illustrating the effect seed treatments with 3% levulinic acid on mean germination percentage for melon seedlings 14 days after planting.

FIG. 7 is a graph illustrating the effect of 3% levulinic acid on mean shoot length and mean root length of melon seedlings 14 days after germination.

The drawings are described in greater detail in the description and examples below.

The details of some exemplary embodiments of the methods and systems of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of medicine, organic chemistry, biochemistry, molecular biology, pharmacology, and the like, which are within the skill of the art. Such techniques are explained fully in the literature.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the following terms have the meanings ascribed to them unless specified otherwise. In this disclosure, “comprises,” “comprising,” “containing” and “having” and the like can have the meaning ascribed to them in U.S. Patent law and can mean “includes,” “including,” and the like; “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments.

Prior to describing the various embodiments, the following definitions are provided and should be used unless otherwise indicated.

### DEFINITIONS

In describing and claiming the invention, the following terminology will be used in accordance with the definitions set forth below.

The term “microorganism” or “microbe” as used herein is intended to include any bacterial species including, but not limited to, coliforms (Escherichia spp., Salmonella spp., and the like), Bacillus spp. and phytobacteria, or spores formed by any of these.

The term “phytobacteria” as used herein refers to species of bacteria that induce pathologies in plants including, but not limited to: Burkholderia ambifaria, B. andropogonis, B. anthina, B. brasilensis, B. calcdonica, B. caribensis, B. caryophylli, B. cenocepacia, B. cepacia, B. cepacia complex, B. dolosa, B. fungorum, B. gladioli, B. glathei, B. glumae, B. graminis, B. hospita, B. kururiensis, B. mallei, B. multivorans, B. oklahomensis, B. phenazinium, B. phenoliruptrix, B. phymatum, B. phytofirmans, B. plantarii, B. pseudomallei, B. pyrrocinia, B. sacchari, B. singaporensis, B. sordidicola, B. stabilis, B. terricola, B. thailandensis, B. tropica, B. tuberum, B. ubonensis, B. unamae, B. vietnamiensis, B. xenovorans, Erwinia amylovora, E. aphidicola, E. billingiae, E. carotovora (now called Pectobacterium carotovorum), E. chrysanthemi, E. mallotivora, E. papayae, E. persicina, E. psidii, E. pyrifoliae, E. rhapontici, E. toletana, E. tracheiphila, Pantoea ananatis, P. citrea, Pseudomonas syringae, Xanthomonas albilineans, X. alfalfae, X. ampelina, X. arboricola, X. axonopodis, X. boreopolis, X. badrii, X. bromi, X. campestris, X. assayae, X. citri, X. codiaei, X. cucurbitae, X. cyanopsidis, X. cynarae, X. euvesicatoria, X., ragariae, X. gardneri, X. holcicola, X. hortorum, X. hyacinthi, X. malvacearum, X. maltophilia, X. anihotis, X. melonis, X. oryzae, X. papavericola, X. perforans, X. phaseoli, X. pisi, X. populi, X. acchari, X. theicola, X. translucens, X. vasicola, X. vesicatoria, and the like.

Phytobacteria also include Phytoplasma bacteria such as Ca. Phytoplasma allocasuarinae, Ca. Phytoplasma asteris, Ca. Phytoplasma aurantifolia, Ca. Phytoplasma australiense, Ca. Phytoplasma brasiliense, Ca. Phytoplasma castaneae, Ca. Phytoplasma cocostanzaniae, Ca. Phytoplasma cocosnigeriae, Ca. Phytoplasma cynodontis, Ca. Phytoplasma fraxini, Ca. Phytoplasma japonicum, Ca. Phytoplasma luffae, Ca. Phytoplasma mali, Ca. Phytoplasma oryzae, Ca. Phytoplasma palmae, Ca. Phytoplasma phoenicium, Ca. Phytoplasma pruni, Ca. Phytoplasma prunorum, Ca. Phytoplasma pyri, Ca. Phytoplasma rhamni, Ca. Phytoplasma solani, Ca. Phytoplasma spartii, Ca. Phytoplasma trifolii, Ca. Phytoplasma ulmi, Ca. Phytoplasma vitis and, Ca. Phytoplasma ziziphi, and the like.

The term “microorganism” as used herein also includes fungi such as (but not limited to) those of the Pyrenophora (Pyrenophora semeniperda, P. teres, P. graminea and P. tritici-repentis), Bipolaris (B. cactivora, B. cookie, B. incurvate, B. sacchan) and Cochliobolus (C. carbonum, C. heterostrophum, C. lunatus, C. stenospilus), Erysiphe genera and the like.

The term “antimicrobial” as used herein refers to a compound that exhibits microbicidal or microbiostatic properties that enable the compound to kill, destroy, inactivate, or neutralize a microorganism; or to prevent or reduce the growth, ability to survive, or propagation of a microorganism.

The term “microbial load” as used herein refers to a population of microbial organisms colonizing a vegetable seed or a sprout thereof. The microbial load is not limited to phytobacteria that may or may not be harmful to the colonized seed or sprout thereof, but may also include opportunistic colonizers that reside on or in a seed or a sprout thereof as a result of mere contact with a population of such organisms.

The term “acid” as used herein refers to any chemical compound that, when dissolved in water, gives a solution with a hydrogen ion activity greater than in pure water, i.e. a pH less than 7.0. An “organic acid” is a carbon-containing compound (except for carbonic acid) with acidic properties. A monoprotic acid is an acid that is able to donate one proton per molecule during ionization.

The terms “effective” amount of an anti-microbial composition as used herein refers to a concentration of active agent that provides the desired effect, i.e., log order reduction in surface microbial counts without reducing the viability of the treated vegetable seed or the sprout thereof, or the ability of the seed to germinate.

The term “organoleptic properties” as used herein refers to properties that can be detected by human or animal senses (taste, color, odor, feel) unaided by mechanical and analytical devices.

### DESCRIPTION

The present disclosure encompasses methods of using antimicrobial compositions comprising levulinic acid and a detergent for reducing the microbial load of a seed or a germinated sprout thereof. The methods of the present disclosure are useful for reducing the microbial load of seeds or seedlings colonized or infected with phytobacteria. Additionally, the wash methods of the disclosure are effective in significantly decreasing microbial populations resident on or within seeds and seedlings, when the microbial populations are adventitious colonizations by bacteria potentially pathogenic to a consumer. For example, the seeds or the parent plants may have been irrigated with water contaminated by fecal organisms including, but not limited to, E. coli, S. typhimurium, and the like. Such bacteria can attach to developing seeds or seedlings, proliferate or merely reside thereon and thereby constitute a threat of digestive tract illnesses to the consumer of food derived from such plant products.

The data of the present disclosure supports the efficacy of the methods to decrease seed- and seedling-borne microbial populations while not significantly decreasing the viability of the treated material. Thus propagation of the seeds is not adversely affected, their health can be improved, providing economic and safety benefits.

In these studies, an antimicrobial wash was evaluated for its ability to kill bacteria. As models, but not intended to be limiting, Acidovorax avenae subsp. citrulli, the causal agent of bacterial fruit blotch of cucurbits (melon, watermelon, pumpkins, etc.), and several other phytobacteria, including Xanthomonas campestris pv. campestris (black rot of crucifiers), Xanthomonas vesicatoria (bacterial spot of pepper), Pantoea ananatis (center rot of onion), Erwinia carotovora subsp. carotovora (Erwinia soft rot), and Clavibacter michiganensis subsp. michiganesis (bacterial canker of tomato) were used. The efficacy of the wash as a seed treatment was also evaluated and assessed with respect to its impact on fruit and seed quality, the germination of the seeds, and the health and viability of the resulting sprouts and seedlings.

The ability of combinations of levulinic acid and SDS to kill a range of plant pathogenic bacteria in vitro was tested. Nutrient broth liquid cultures were supplemented with 3%, 1%, or 0.5% levulinic acid. A range of gram-negative plant pathogenic bacteria was screened, including Acidovorax avenae subsp. citrulli, Erwinia (Pectobacterium) carotovora subsp. carotovora, Xanthomonas campestris pv. campestris, Xanthomonas axonopodis pv. vesicatoria and Pantoea ananatis subsp. ananatis. In all instances, 0.5% levulinic acid killed the pathogens, i.e. reduced the number of viable cells in the liquid broth. Broth cultures of all the bacteria were plated after the incubation period and showed that the action of the levulinic acid was bactericidal rather than bacteristatic. Each bacterium was evaluated 10 times and the experiment was repeated.

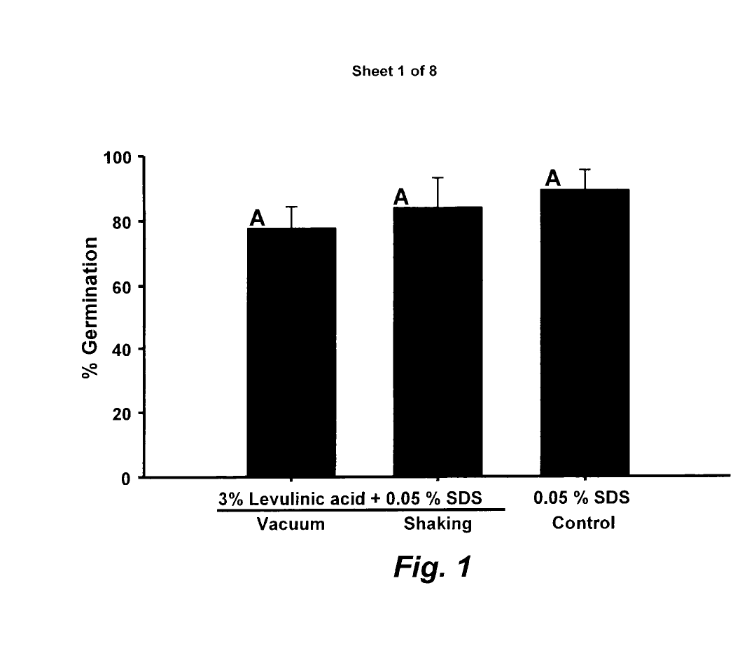

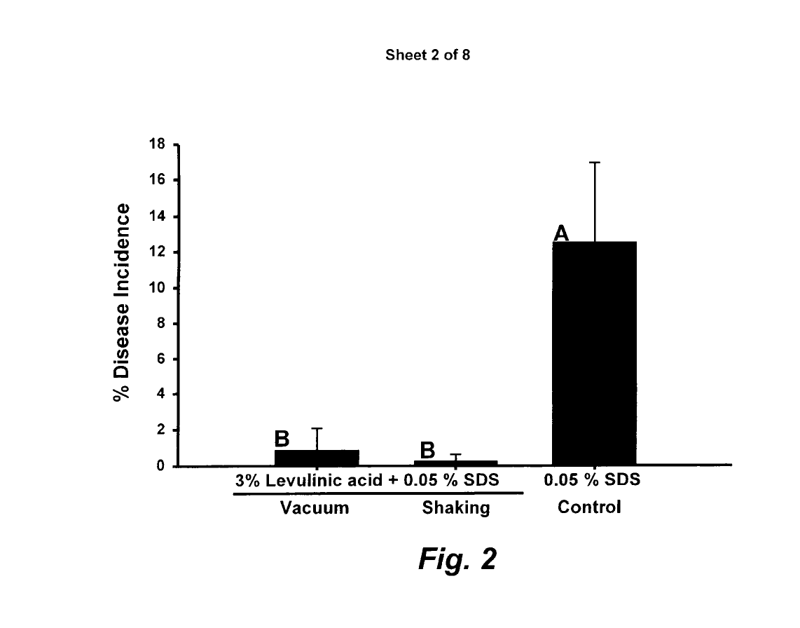

With regard to levulinic acid as a seed treatment, 3% levulinic acid and 0.05% SDS was applied as a soak or a vacuum treatment (both for 1 hr) to 4 replicates of 100 watermelon seeds naturally infected with Acidovorax avenae subsp. citrulli. Seeds treated with 0.05% SDS served as a negative control. Germination percentages, as shown in FIG. 1, were 78% and 84% for seeds that were vacuum-infiltrated or soaked in levulinic acid, respectively, and there was no statistically significant difference in germination between levulinic acid-treated seeds and those treated with 0.05% SDS (89.25%). However, seedling disease transmission, as shown in FIG. 2, was 14.5% for the control seeds while it was 1% and 0.3% for seeds treated with levulinic acid by vacuum infiltration and shaking, respectively. The differences in seedling transmission of bacterial fruit blotch of watermelon for seeds treated with levulinic acid versus 0.05% SDS were statistically significant. Hence levulinic acid almost completely eradicated A. avenae subsp. citrulli from naturally infested watermelon seeds without significant negative impacts on seed physiology (indicated by germination percentage).

Many antimicrobial treatments, including heat and chemicals such as sodium hypochlorite, calcium hypochlorite, acidified sodium chlorite, acidified chlorine dioxide, sodium phosphate, peroxyacetic acid, and hydrogen peroxide have been evaluated to reduce of E. coli O157:H7 contamination on alfalfa seeds. However, none of the above chemical treatments has been shown to eliminate E. coli O157:H7 on alfalfa seeds and sprouts. The results of using the methods encompassed by the present disclosure indicated concentrations and exposure times for antimicrobial treatment using levulinic acid plus sodium dodecyl sulfate effective in reducing E. coli O157:H7 and Salmonella contamination on alfalfa seeds and to measure the effect of the treatment on seed germination. Alfalfa seeds were inoculated with a 5-strain mixture of E. coli O157:H7 or S. typhimurium DT 104 at 10⁸ CFU/g and then dried at 21° C. in a laminar hood for up to 72 hr. E. coli O157:H7 counts at 4 hr, 24 hr, 48 hr, and 72 hr of drying were about 8.1, about 4.8, about 4.0, and about 4.0 log₁₀ CFU/g, respectively; and S. typhimurium DT 104 counts were about 6.6, about 4.4, about 4.3, and about 4.1 log₁₀ CFU/g, respectively.

Treatment with 0.5% levulinic acid and 0.05% SDS for 5 min at 21° C. reduced E. coli O157:H7 and S. typhimurium DT 104 populations by about 5.6, greater than 3.3, greater than 2.4, greater than 2.3; and about 6.4, greater than 2.7, about 4.3, about 2.4 log₁₀ CFU/g on seeds dried for 4 hr, 24 hr, 48 hr, and 72 hr, respectively. Seeds contaminated with 10⁴ E. coli O157:H7/g, dried for 2 hr at 21° C., and treated with 0.5% levulinic acid plus 0.05% SDS at 40° C. for up to 5 min were E. coli O157:H7-negative by direct plating (less than five E. coli O157:H7/g) but were positive by enrichment culture.

Data from this study, therefore, indicate that levulinic acid is an effective antimicrobial compound against a range of gram-negative and gram-positive plant pathogenic bacteria. Even at 0.5% concentration, the solution limited in vitro population growth for all pathogens tested. Seed treatment with 3% levulinic acid suppressed the seed-to-seedling transmission of BFB on watermelon and melon seedlings using naturally infested seedlots. For melon and watermelon seed, treatment with levulinic acid did not have a statistically significant effect on germination. There was also no noticeable effect on melon shoot elongation by 14 days after planting. However, the data suggest that seed treatment with 3% levulinic acid may delay elongation and development of melon roots.

E. coli O157:H7 populations were reduced by about 3 log CFU/g by drying at 21° C. for 24 h. Treating these inoculated seeds with calcium hypochlorite or 0.5% levulinic acid plus 0.05% SDS for 5 min killed most E. coli O157:H7, with the small number of survivors (<5 CFU/g) only detectable by an enrichment culture assay. Similar results were observed with seeds on which the inocula were dried for 48 hr and 72 hr (Table 1).

S. typhimurium DT 104 populations on alfalfa seeds after drying in a laminar flow hood for 4 hr were consistently from about 10⁶ to about 10⁷ CFU/g after treatment with PBS. Treatment with 20,000 ppm calcium hypochlorite, or 0.5% levulinic acid plus 0.05% SDS, eliminated all Salmonella within 5 min (Table 2), respectively.

Drying inocula on seeds for 24 hr, 48 hr, or 72 hr reduced Salmonella populations by approximately an additional 2 log CFU/g, including treatment with PBS. Treatments with 20,000 ppm calcium hypochlorite or 0.5% levulinic acid plus 0.05 SDS for 5 min inactivated most Salmonella, with survivors (<5 CFU/g) only detectable by enrichment culture (Table 2).

All treatment solutions were pathogen-negative by both direct plating and enrichment culture assays. Extended drying for 1 to 5 days of pathogen inocula on seeds influenced the resistance of Salmonella and E. coli O157:H7 to disinfectant treatments. None of the samples treated for 10 min with 20,000 ppm calcium hypochlorite or 0.5% levulinic acid and 0.05% SDS were pathogen-positive by direct plating but were sporadically positive by enrichment culture assay. Pathogen-inoculated seeds treated under commercial conditions in a nylon bag aerated in a stainless steel tank with 20,000 ppm calcium hypochlorite or 0.5% levulinic acid plus 0.05% SDS were pathogen-positive at <5 CFU/g, with both treatments being comparable in reducing E. coli O157:H7 and Salmonella. However, the treatment system may be a contributing factor to the pathogens surviving the antimicrobial treatments. Thus, it is possible that the seeds in 5 to 15-lb lots in a nylon bag were not all fully exposed to the treatment solutions, thereby resulting in survivors. A treatment process that ensures each seed receives exposure to the treatment solution for at least 5 mins is contemplated to increase treatment efficacy.

The 0.5% levulinic acid plus 0.05% SDS treatment for 1 hr at 21° C. yielded greater germination rates (80%) than either the tap water (70.8%) or 20,000 ppm calcium hypochlorite (47.3%) treatments, as shown in Table 4.

Results with E. coli O157:H7-inoculated alfalfa seeds revealed that treatment with 20,000 ppm calcium hypochlorite or 0.5% levulinic acid plus 0.05% SDS for up to 60 min can reduce the pathogen population by greater than 6 and 5 log CFU/g, respectively. However, our data indicate that treatment by 0.5% levulinic acid plus 0.05% SDS does not affect the germination rate in treated alfalfa seeds, as shown in Table 4.

In 1999, the FDA (Food & Drug Administration (1999) Fed. Reg. 64:57893-57902) published a guidance document to help seed producers and spout growers enhance the safety of their products. Specific measures in these guidelines included the implementation of seed disinfection and microbiologic tests of water used to grow sprouts. Although the methods suggested by FDA appeared to have reduced the risk of sprout-related human illness, CDC's electronic Foodborne Outbreak Surveillance System has reported thirteen Salmonella and three E. coli O157:H7 outbreaks associated with sprouts from 2000 to 2007 (Safranek et al., (2009) MMWR 58: 1-3; Sivapalasingam et al., (2004) J. Food Prot. 67: 2342-2353; Stewart (2001) J. Food Prot. 64: 618-622). Process failures, including inadequate disinfection, sampling, and testing procedures, and incorrect interpretation of test results, were identified as contributing factors in some of these investigations.

Similar inactivation trends of E. coli O157:H7 and Salmonella typhimurium DT 104 were observed for treatments of alfalfa seeds with 20,000 ppm calcium hypochlorite, pH 11.4, and 0.5% levulinic acid plus 0.05% SDS, pH 3.0. The use of 20,000 ppm calcium hypochlorite treatment in the seed industry may help reduce the risk of pathogen contamination, but its use provides undesirable working conditions that may adversely affect human health. Such a treatment, however, is also highly corrosive to equipment. The levulinic acid plus SDS treatment according to the present disclosure would provide a useful alternative by providing effective antimicrobial activity, a safe working environment and being noncorrosive to equipment.

The present disclosure, therefore, encompasses embodiments of a method of reducing the microbial load of a vegetable seed or a sprout thereof, comprising contacting the vegetable seed or the sprout thereof, with a composition comprising levulinic acid and a detergent for a period suitable for reducing a microbial population of the vegetable seed or the sprout thereof.

In embodiments of the methods of the disclosure, the detergent can be sodium dodecyl sulfate (SDS).

In embodiments of the methods of the disclosure, the concentration of levulinic acid in the composition is between about 0.1% wt/vol and about 5% wt/vol levulinic acid.

In some embodiments of the methods of the disclosure, the concentration of levulinic acid in the composition is about 3% levulinic acid.

In embodiments of the methods of the disclosure, the concentration of SDS in the composition is between about 0.01% wt/vol and about 0.5% wt/vol SDS.

In embodiments of the methods of the disclosure, the concentration of SDS in the composition is about 0.05% SDS.

In one embodiment of the method of the disclosure, the composition comprises about 3% wt/vol levulinic acid and about 0.05% wt/vol SDS.

In embodiments of the methods of the disclosure, the step of contacting the vegetable seed can comprise immersing the vegetable seed or the sprout thereof in the composition.

In embodiments of the methods of the disclosure, the step of contacting the vegetable seed or the sprout thereof, with the composition can comprise contacting the seed with the composition and applying a vacuum thereto, whereby air from the vegetable seed or the sprout thereof, can be replaced with a volume of the composition.

In embodiments of the methods of the disclosure, the composition can reduce a bacterial population located on the exterior surface of the seed coat (testa) of a vegetable seed, located in or on the seed contents beneath the testa, or located on and beneath the testa of the vegetable seed.

In some embodiments of the methods of the disclosure, the composition can reduce a microbial population located on the exterior surface of the seed coat (testa) of a vegetable seed, located in or on the seed contents beneath the testa, or located on and beneath the testa of the vegetable seed, wherein the microbial population is a bacterial population.

The specific examples below are to be construed as merely illustrative, and not limitative of the remainder of the disclosure in any way whatsoever. Without further elaboration, it is believed that one skilled in the art can, based on the description herein, utilize the present disclosure to its fullest extent. All publications recited herein are hereby incorporated by reference in their entirety.

It should be emphasized that the embodiments of the present disclosure, particularly, any “preferred” embodiments, are merely possible examples of the implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure, and the present disclosure and protected by the following claims.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified.

### EXAMPLES

### Example 1

### Bacterial Strains:

Five isolates of Escherichia coli O157:H7, including strain 932 (human isolate), E009 (beef isolate), E0018 (cattle isolate), E0122 (cattle isolate), E0139 (deer jerky isolate); and five isolates of Salmonella typhimurium DT104, including strain H2662 (cattle isolate), 11942A (cattle isolate), 13068A (cattle isolate), 152N17-1 (dairy isolate) and H3279 (human isolate) were used. Nalidixic acid-resistant (50 μg/ml) E. coli O157:H7 were used to facilitate enumeration. Each E. coli O157:H7 and Salmonella strain was grown in tryptic soy broth (TSB, Beckon Dickinson, Sparks, Md.) at 37° C. for 18 hr. Approximately equal cell numbers of each of the five strains were combined and used as a 5-strain mixture with cell numbers being adjusted by spectrophotometric (Spectronic Instruments, Rochester, N.Y.) determination as described in Zhao et al., (2009) J. Food Prot. 72: 928-936, incorporated herein by reference in its entirety. Bacterial cell numbers were confirmed by plating 0.1 ml of serial dilutions (1:10) in 0.1% peptone on tryptic soy agar (TSA, Beckon Dickinson) and Sorbitol MacConkey agar (SMA, Oxoid, Hampshire, UK) for E. coli O157:H7, and TSA and XLD agar (Beckon Dickinson) for Salmonella and incubating all plates at 37° C. for 24 hr, after which colonies were counted.

### Chemicals and Chemical Treatments:

Levulinic acid (0.5%) and 0.05% sodium dodecyl sulfate (SDS) obtained from Sigma-Aldrich (St. Louis, Mo.) were tested in combination at 21±2° C. for their antimicrobial activity to E. coli O157:H7 and S. typhimurium on alfalfa seeds as a wash treatment. Calcium hypochlorite (Arch Chemicals, Smyrna, Ga.) at 20,000 μg/ml (ppm) was used as the positive control, and deionized water was used as the negative control.

### Water:

Deionized, unchlorinated water filter sterilized through a 0.2-μm regenerated cellulose filter (Corning Inc., Corning, N.Y.) was used to prepare chemical solutions and tap water was used for all other purposes for seed germination and pathogen inactivation studies.

### Inoculation of Alfalfa Seeds:

Alfalfa seeds were obtained from Caudill Seeds Co. (Louisville, Ky.), and had a germination percentage of approximately 91%. Before each trial, 25 ml of sterile tap water and 25 g of alfalfa seeds were added to a WHIRL-PAK® bag (Nasco, Fort Atkinson, Wis.) and pummeled in a stomacher blender at 150 rpm for 1 min. Duplicate 0.1 ml portions of the contents were plated on SMA, XLD, and TSA plates to detect E. coli O157:H7 and Salmonella, and enumerate aerobic bacteria counts according to the protocols described below. Only E. coli O157:H7-negative and Salmonella-negative alfalfa seeds were used. Dry seeds (50 g) were individually placed in a sterilized glass beaker (1 L) and 5 ml of a mixture of E. coli O157:H7 or S. typhimurium DT 104 (high inocula at 10⁸-10⁹ CFU/ml and low inocula at 10³-10⁴ CFU/ml) was inoculated on the surface of the seeds in each glass beaker under a laminar flow hood. A sterile plastic spoon was used to mix for 2 min the seeds with bacterial suspension. The glass beakers were held in a laminar flow hood for 1 hr, 4 hr, 24 hr, 48 hr, and 72 hr with intermittent mixing by plastic spoon before use for chemical treatment.

### Inoculation of Alfalfa Seeds in Large Quantities:

Dry seeds (1.36, 2.26, 4.53, or 6.8 Kg) were placed in a sterilized stainless steel plate in a laminar flow hood were inoculated on the surface with a 50:1 (wt/v) ratio of alfalfa seeds to a 5-strain mixture of E. coli O157:H7 or S. typhimurium DT104 (10⁸-10⁹ CFU/ml or 10³-10⁴ CFU/ml). A sterilize plastic spoon was used to mix for 2 min the seeds with each bacterial suspension. The seeds were held in the laminar flow hood for 1 hr with intermittent mixing by plastic spoon before being placed into a nylon bag (85 cm×40 cm) immediately before receiving the levulinic acid plus SDS or calcium hypochlorite treatment.

### Example 2

Inactivation of E. coli O157:H7 and Salmonella on Alfalfa Seeds:
Inoculated, dried alfalfa seeds (50 g samples) were placed in a 1000 ml glass beaker containing 200 ml of treatment solution and agitated by a magnetic stir bar at 150 ppm at 21° C. for 0, 1, 2, 5, 10, 20, 30, and 60 min. Following treatment, 25 g of seeds was placed in a stomacher bag containing 25 ml 0.1M phosphate buffer, pH 7.2 (PBS) for levulinic acid plus SDS-treated seeds or neutralizing buffer (50×) for calcium hypochlorite-treated seeds and pummeled for 1 min. at 150 rpm in a stomacher blender (Seward, Ltd., Worthing, England). The suspension was serially (1:10) diluted in 0.1% peptone water and 0.1 ml of each dilution was surface-plated in duplicate onto TSA and Sorbitol MacConkey agar containing 50 μg nalidixic acid/ml (TSA-NA and SMA-NA) for E. coli O157:H7, and on TSA and XLD containing ampicillin (32 μg/ml), tetracycline (16 μg/ml) and streptomycin (64 μg/ml) (TSA+ and XLD+) for S. typhimurium DT 104. All plates were incubated at 37° C. for 48 hr. Colonies typical of E. coli O157:H7 (colorless) and for Salmonella (black) were randomly selected from plates with the highest dilution for confirmation of E. coli or Salmonella by biochemical tests (API 20E assay, bioMérieux, Hazelwood, Mo.) and for confirmation by latex agglutination assay (Oxoid).

When E. coli O157:H7 or Salmonella were not detected by direct plating, a selective enrichment in universal pre-enrichment broth (UPB, Beckton Dickinson) was performed by incubating 25 ml of macerated, treated seeds in a 500 ml flask containing 225 ml of UPB for 24 hr at 37° C. Following enrichment, 1 ml was transferred to 10 ml of selenite cystine broth (Beckton Dickinson) and incubated for 24 hr at 37° C. Following incubation, a 10 μl loopful from the broth tube was plated in duplicate onto XLD plates, and incubated for 24 hr at 37° C. Colonies with typical Salmonella spp. morphology were selected and transferred one more time on XLD plates and incubated for 24 hr at 37° C.

All presumptive Salmonella isolates were tested by the Salmonella latex agglutination assay, positive isolates were tested by the API 20E assay for biochemical characteristics for identification of Salmonella. Selective enrichment for E. coli O157:H7 was done according to the protocol reported by Zhao, et al., (2009) J. Food Prot. 72: 928-936, incorporated herein by reference in its entirety. Inoculated seeds treated with water only were used as the negative control and those treated with 20,000 ppm calcium hypochlorite as the positive control. Studies with all chemical treatments were done in duplicate or ten times and results were reported as mean±standard deviation.

### Example 3

### Seed Treatment in a Commercial Air-Washer:

The washing container consisted of a stainless steel bin measuring 6×6×6 ft with an external pump delivering filtered air. On the bottom of the bin, pipes were fitted to deliver air into the liquid sanitizer by an air pump. The washing apparatus generally held 302 liters of solution and can wash seeds 4 to 6 nylon bags and each bag can hold 6.8 kg of seeds.

### Example 4

### Determination of Seed Germination Percentage:

Treated and non-treated seeds (5 g or number of seeds counted per replicate) were placed on the surface of a plastic tray. Three plastic trays were stacked vertically and top tray was filled with 100 ml of sterile deionized water or tap water which fed to the lower trays to maintain uniform moisture content for the seeds. The seeds were incubated at 22° C. for 72 hr. Each evaluation was based on three replicates of 200-400 seeds each. A seed was considered to have germinated if the seed coat was broken and a visible sprout was extending at least 8 mm from the original seed. Swollen seeds or ruptured seeds with sprout tissue still inside were not counted as germinated, because such seeds rarely sprouted completely after an additional 24 hr of incubation.

### Example 5

The population of E. coli O157:H7 on alfalfa seeds after inoculation and dried in a laminar hood for 4 hr was consistently at 10⁸ CFU/g for PBS-treated seeds. Seeds treated with 20,000 ppm calcium hypochlorite or 0.5% levulinic acid plus 0.05% SDS for up to 60 min reduced E. coli O157:H7 populations by greater than 6 and 5 log CFU/g, respectively.

The population of E. coli O157:H7 was reduced by about 3 log CFU/g during drying for 24 hr. Treatment with calcium hypochlorite or 0.5% levulinic acid plus 0.05% SDS for 5 min inactivated almost all E. coli O157:H7, with the pathogen only detectable on seeds by selective enrichment culture. Similar results were obtained with seeds dried for 48 hr or 72 hr, as shown in Table 1.

TABLE 1
E. coli O157:H7 counts on alfalfa seeds inoculated with 10⁸ CFU/g, dried at 21° C. for
different times, then treated with calcium hypochlorite, or levulinic acid:SDS

| Treatment method | | | | | | | | |
|---|---|---|---|---|---|---|---|---|
| | E. coli O157:H7 counts (CFU/g) on seeds dried for 4 hr | | | | | | | |
| | and treated for mins: | | | | | | | |
| | 0^{a} | 1 | 2 | 5 | 10 | 20 | 30 | 60 |
| 0.1 M PBS, pH 7.2 | 8.1 ± | 8.2 ± | 8.2 ± | 8.1 ± | 8.2 ± | 8.3 ± | 8.3 ± | 8.1 ± |
| | 0.4 | 0.1 | 0.1 | 0.2 | 0.1 | 0.3 | 0.1 | 0.2 |
| 20,000 ppm, Ca(OCl)₂, pH 11.4 | +^{b} | + | −^{c} | + | 1.7± | 2.0± | 1.7± | + |
| 0.5% levulinic acid + 0.05% | 1.7 ± | 2.7 ± | 3.0 ± | 2.5 ± | 2.8 ± | 2.0 ± | 2.6 ± | 2.2 ± |
| SDS, pH 3.2 | 0.2 | 0.1 | 0.2 | 0.2 | 0.1 | 0.2 | 0.2 | 0.1 |
| | E. coli O157:H7 counts (CFU/g) on seeds dried for 24 hr | | | | | | | |
| | and treated for mins: | | | | | | | |
| | 0 | 1 | 2 | 5 | 10 | 20 | 30 | 60 |
| 0.1 M PBS, pH 7.2 | 4.7 ± | 4.8 ± | 4.9 ± | 5.0 ± | 4.7 ± | 4.9 ± | 4.8 ± | 4.9 ± |
| | 0.2 | 0.3 | 0.1 | 0.3 | 0.2 | 0.3 | 0.1 | 0.1 |
| 20,000 ppm, Ca(OCl)₂, pH 11.4 | + | − | − | − | + | − | − | + |
| 0.5% levulinic acid + 0.05% | 1.7 ± | 1.4 ± | 0.7 ± | + | + | + | − | + |
| SDS, pH 3.2 | 0.1 | 0.1 | 0.2 | | | | | |
| | E. coli O157:H7 counts (CFU/g) on seeds dried for 48 hr | | | | | | | |
| | and treated for min: | | | | | | | |
| | 0 | 1 | 2 | 5 | 10 | 20 | 30 | 60 |
| 0.1 M PBS, pH 7.2 | 4.0 ± | 4.1 ± | 4.0 ± | 4.1 ± | 4.1 ± | 4.0 ± | 4.0 ± | 3.9 ± |
| | 0.6 | 0.3 | 0.2 | 0.0 | 0.2 | 0.3 | 0.2 | 0.3 |
| 20,000 ppm, Ca(OCl)₂, pH 11.4 | + | − | + | − | − | − | − | − |
| 0.5 levulinic acid:0.05% SDS, | 2.7 ± | 2.1 ± | + | + | + | + | + | + |
| pH 3.2 | 0.2 | 0.3 | | | | | | |
| | E. coli O157:H7 counts (CFU/g) on seeds dried for 72 hr | | | | | | | |
| | and treated for min: | | | | | | | |
| | 0 | 1 | 2 | 5 | 10 | 20 | 30 | 60 |
| 0.1 M PBS, pH 7.2 | 3.8 ± | 3.9 ± | 3.9 ± | 4.0 ± | 4.0 ± | 4.1 ± | 4.0 ± | 4.1 ± |
| | 0.4 | 0.3 | 0.2 | 0.3 | 0.2 | 0.1 | 0.1 | 0.2 |
| 20,000 ppm, Ca(OCl)₂, pH 11.4 | + | + | + | − | + | + | − | − |
| 0.5% levulinic acid:0.05% SDS, | 1.9 ± | 1.4 ± | 1.1 ± | + | + | − | − | + |
| pH 3.2 | 0.1 | 0.2 | 0.2 | | | | | |

^{a}The actual time 0 was delayed by 20 to 30 seconds due to time for sample processing
^{b}+, below the minimum detection level by direct plating (<0.7 log CFU/ml), but positive by enrichment culture
^{c}−, negative by direct plating and enrichment culture

The population of S. typhimurium DT 104 on alfalfa seeds after drying in a laminar flow hood for 4 hr was consistently at 10⁶ to 10⁷ CFU/g for PBS-treated seeds. Results were similar for seeds treated with 20,000 ppm calcium hypochlorite and 0.5% levulinic acid plus 0.05% SDS with no detectable Salmonella after 5 min of treatment, as shown in Table 2.

Drying inoculated Salmonella on alfalfa seeds for 24 hr, 48 hr, or 72 hr decreased the population of Salmonella by ca. 2 log CFU/g. Both treatments of 20,000 ppm calcium hypochlorite and 0.5% levulinic acid plus 0.05% SDS for 5 min reduced Salmonella to levels only detectable by selective enrichment culture (Table 2).

TABLE 2
S. typhimurium DT 104 counts on alfalfa seeds inoculated with 10⁸ CFU/g, dried at
21° C. for different times, then treated with calcium hypochlorite or leveulinic acid:SDS

| Treatment method | | | | | | | | |
|---|---|---|---|---|---|---|---|---|
| | S. typhimurium DT 104 counts (CFU/g) in seeds dried | | | | | | | |
| | for 4 hr and treated for mins: | | | | | | | |
| | 0^{a} | 1 | 2 | 5 | 10 | 20 | 30 | 60 |
| 0.1 M PBS, pH 7.2 | 6.4 ± | 6.8 ± | 6.3 ± | 6.4 ± | 6.6 ± | 6.3 ± | 6.3 ± | 6.0 ± |
| | 0.2 | 0.3 | 0.4 | 0.1 | 0.3 | 0.1 | 0.2 | 0.3 |
| 20,000 ppm, Ca(OCl)₂, pH 11.4 | +^{b} | −^{c} | − | − | − | − | − | − |
| 0.5% levulinic acid:0.05% SDS, | 3.1 ± | + | + | − | − | − | − | − |
| pH 3.2 | 0.2 | | | | | | | |
| | S. typhimurium DT 104 counts (CFU/g) in seeds dried | | | | | | | |
| | for 24 hr and treated for mins: | | | | | | | |
| | 0 | 1 | 2 | 5 | 10 | 20 | 30 | 60 |
| 0.1 M PBS, pH 7.2 | 4.4 ± | 4.2 ± | 4.3 ± | 4.4 ± | 4.5 ± | 4.6 ± | 4.6 ± | 4.3 ± |
| | 0.2 | 0.1 | 0.1 | 0.3 | 0.4 | 0.1 | 0.2 | 0.4 |
| 20,000 ppm, Ca(OCl)₂, pH 11.4 | + | + | − | − | − | − | − | − |
| 0.5% levulinic acid:0.05% SDS, | 1.6 ± | 2.4 ± | 1.2 ± | + | + | − | − | − |
| pH 3.2 | 0.3 | 0.5 | 0.1 | | | | | |
| | S. typhimurium DT 104 counts (CFU/g) in seeds dried | | | | | | | |
| | for 48 hr and treated for mins: | | | | | | | |
| | 0 | 1 | 2 | 5 | 10 | 20 | 30 | 60 |
| 0.1 M PBS, pH 7.2 | 4.0 ± | 4.1 ± | 4.2 ± | 4.3 ± | 4.2 ± | 4.4 ± | 4.4 ± | 4.3 ± |
| | 0.2 | 0.1 | 0.1 | 0.1 | 0.2 | 0.1 | 0.3 | 0.2 |
| 20,000 ppm Ca(OCl)₂, pH 11.4 | + | + | − | − | + | − | − | − |
| 0.5% levulinic acid:0.05% SDS, | 3.0 ± | + | − | − | + | − | + | − |
| pH 3.2 | 0.1 | | | | | | | |
| | S. typhimurium DT 104 counts (CFU/g) in seeds dried | | | | | | | |
| | for 72 hr and treated for mins: | | | | | | | |
| | 0 | 1 | 2 | 5 | 10 | 20 | 30 | 60 |
| 0.1 M PBS, pH 7.2 | 4.0 ± | 4.0 ± | 3.9 ± | 4.1 ± | 4.1 ± | 4.5 ± | 4.1 ± | 4.2 ± |
| | 0.0 | 0.1 | 0.3 | 0.2 | 0.1 | 0.5 | 0.2 | 0.1 |
| 20,000 ppm, Ca(OCl)₂, pH 11.4 | − | − | − | − | − | + | + | − |
| 0.5% levulinic acid + 0.05% SDS, | 2.3 ± | + | + | + | − | − | + | + |
| pH 3.2 | 0.2 | | | | | | | |

^{a}The actual time 0 was delayed by 20 to 30 seconds due to time for sample processing.
^{b}+, below the minimum detection level by direct plating (<0.7 log CFU/ml), but positive by enrichment culture.
^{c}−, negative by direct plating and enrichment culture.

All samples of calcium hypochlorite, and levulinic acid plus SDS, solutions used for treatment were negative for E. coli O157:H7 or Salmonella by enrichment culture after use. Inoculated seeds treated with 20,000 ppm calcium chlorite or 0.5% levulinic acid and 0.05% SDS in a glass beaker for 10 min then transferred with treatment solution to a stomacher bag and pummeled at 260 rpm for 10 min were negative for E. coli O157:H7 and Salmonella by direct plating method and 8 of 10 treated with 0.5% levulinic acid and 0.05% SDS were E. coli O157H7-positive by enrichment culture, as shown in Table 3.

TABLE 3
E. coli O157:H7 and Salmonella counts of alfalfa seeds with an initial inoculum of 10⁴
CFU/g, dried at 21° C. for 2 hr, treated for 20 min (10 min in beaker and 10 min in a stomacher
bag) at 21° C.

| Treatment method | 1 | 2 | 3 | 4 | 5 | 6 | 7 | 8 | 9 | 10 |
|---|---|---|---|---|---|---|---|---|---|---|
| | E. coli O157:H7 count (log CFU/25 g seeds) in sample No.: | | | | | | | | | |
| Tap water only | 3.2 ± | 3.3 ± | 3.2 ± | 3.1 ± | 3.3 ± | 3.3 ± | 3.2 ± | 3.2 ± | 3.2 ± | 3.2 ± |
| | 0.3 | 0.1 | 0.2 | 0.2 | 0.1 | 0.1 | 0.2 | 0.2 | 0.1 | 0.1 |
| 20,000 ppm, | − | − | − | − | − | ND^{a} | ND | ND | ND | ND |
| Ca(OCl)₂, pH 11.4 | | | | | | | | | | |
| 0.5% levulinic acid + | + | + | + | + | − | + | − | + | + | + |
| 0.05% SDS, pH 3.2 | | | | | | | | | | |
| | E. coli O157:H7 count (log CFU/25 ml treated supernatant) in | | | | | | | | | |
| | sample No.: | | | | | | | | | |
| Tap water only | 2.8 ± | 2.9 ± | 2.8 ± | 2.8 ± | 2.8 ± | 2.8 ± | 2.8 ± | 2.8 ± | 2.8 ± | 2.8 ± |
| | 0.3 | 0.2 | 0.2 | 0.1 | 0.1 | 0.0 | 0.0 | 0.1 | 0.0 | 0.1 |
| 20,000 ppm, | − | − | − | − | − | ND | ND | ND | ND | ND |
| Ca(OCl)₂, pH 11.4 | | | | | | | | | | |
| 0.5% levulinic acid + | − | − | − | − | − | − | − | − | − | − |
| 0.05% SDS, pH 3.2 | | | | | | | | | | |
| | S. typhimurium DT 104 count (log CFU/25 g seeds) in sample No.: | | | | | | | | | |
| Tap water only | 3.3 ± | 3.3 ± | 3.3 ± | 3.3 ± | 3.3 ± | 3.3 ± | 3.3 ± | 3.3 ± | 3.3 ± | 3.3 ± |
| | 0.1 | 0.0 | 0.1 | 0.0 | 0.0 | 0.2 | 0.1 | 0.0 | 0.1 | 0.2 |
| 20,000 ppm, | − | − | − | − | − | ND | ND | ND | ND | ND |
| Ca(OCl)₂, pH 11.4 | | | | | | | | | | |
| 0.5% levulinic acid + | + | + | − | + | + | + | + | − | + | + |
| 0.05% SDS, pH 3.2 | | | | | | | | | | |
| | S. typhimurium DT 104 count (log CFU/25 ml treated supernatant) | | | | | | | | | |
| | in sample No.: | | | | | | | | | |
| Tap water only | 2.9 ± | 2.9 ± | 2.9 ± | 2.9 ± | 2.9 ± | 2.9 ± | 2.9 ± | 2.9 ± | 2.9 ± | 2.9 ± |
| | 0.3 | 0.0 | 0.0 | 0.2 | 0.0 | 0.1 | 0.1 | 0.2 | 0.0 | 0.0 |
| 20,000 ppm, | − | − | − | − | − | ND | ND | ND | ND | ND |
| Ca(OCl)₂, pH 11.4 | | | | | | | | | | |
| 0.5% levulinic acid + | − | − | − | − | − | − | − | − | − | − |
| 0.05% SDS, pH 3.2 | | | | | | | | | | |

^{a}ND, not determined

TABLE 4
Germination rate of alfalfa seeds after treatment with levulinic
acid:SDS or calcium hypochlorite for 1 h at 21° C.

| | | Germination Ratio |
|---|---|---|
| Chemical Treatment | Replica No. | (Percentage) |
| 0.5% levulinic acid:0.05% SDS, | 1 | 166/200 (83) |
| pH 3.2 | 2 | 150/200 (75) |
| | 3 | 164/200 (82) |
| | Average | 80% |
| 20,000 ppm, Ca(OCl)₂ | 1 | 124/200 (62) |
| pH 11.4 | 2 | 68/200 (34) |
| | 3 | 92/200 (46) |
| | Average | 47% |
| Tap water | 1 | 144/200 (72) |
| | 2 | 136/200 (68) |
| | 3 | 145/200 (73) |
| | Average | 71% |
| Deionized water | 1 | 257/300 (85) |
| | 2 | 248/300 (82) |
| | 3 | 236/300 (78) |
| | Average | 82% |

Germination results revealed that treatment with 0.5% levulinic acid plus 0.05% SDS for 1 hr at 21° C. did not adversely affect alfalfa seed germination compared to the control treatment with tap water, whereas, treatment with 20,000 rpm calcium hypochlorite for 1 hr substantially reduced germination percentage (47% with sodium hypochlorite vs. 71% with tap water).

### Example 6

### Effect of Levulinic Acid on the In Vitro Growth of Phytopathogenic Bacteria:

The effect of levulinic acid on in vitro growth of a range of phytobacteria was determined using a Microbiology Reader BioscreenC (Transgalactic Ltd.; Helsinki, Finland) according to manufacturer's instructions. Briefly, inoculum was generated by transferring one colony of each bacterium from a three-day-old nutrient agar culture (Difco) to 5 ml of nutrient broth. Broth cultures were incubated overnight at 30° C. with continuous agitation and cells from 1 ml of broth were harvested by centrifugation (16,200×g) for 3 min and adjusted to about 3.0×10⁸ CFU/ml (OD_{A600 nm}=0.3) spectrophotometrically (Spectronic 20, Bausch and Lomb, Rochester, N.Y.). Cell suspensions were ten-fold serially diluted to desired concentrations, and 10 μl of each suspension was transferred to a single well in a honeycomb plate (Oy Growth Curves AB Ltd., Helsinki, Finland) containing 190 μl of nutrient broth amended with 3%, 1% or 0.5% levulinic acid. This yielded a starting suspension of about 1.5×10⁴ CFU/ml. The microplate containing ten replicates of each bacterium×levulinic acid concentration treatment was incubated at 30° C. with continuous agitation in a BioscreenC MBR incubator/reader. Optical density measurements of each well were taken at a wavelength of 600 nm at 30 min intervals for 30 hr. Using these data the minimum inhibitory concentration of levulinic acid was estimated.

### Effect of Levulinic Acid on the In Vitro Growth of Phytopathogenic Bacteria:

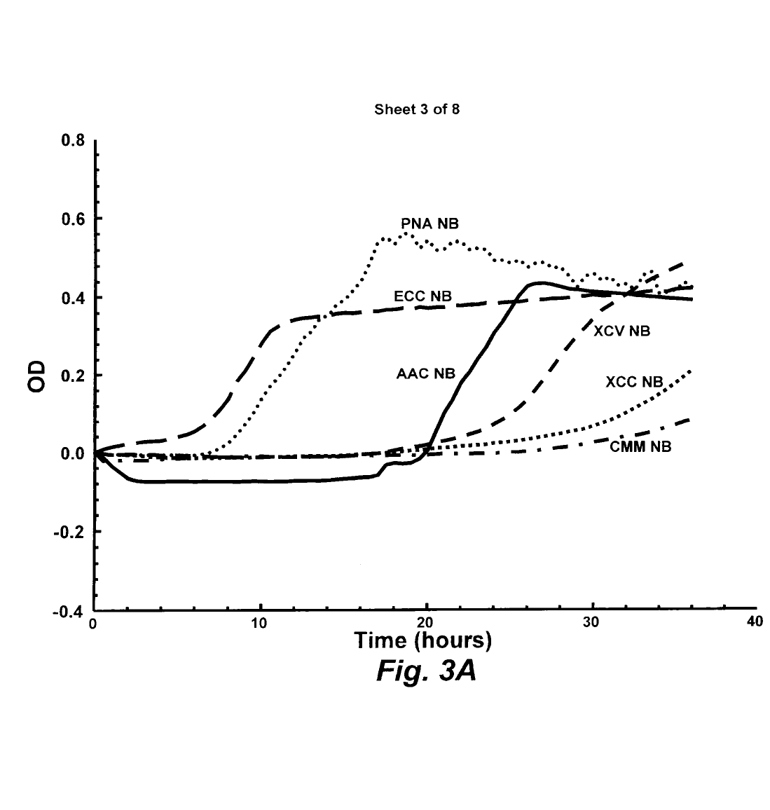

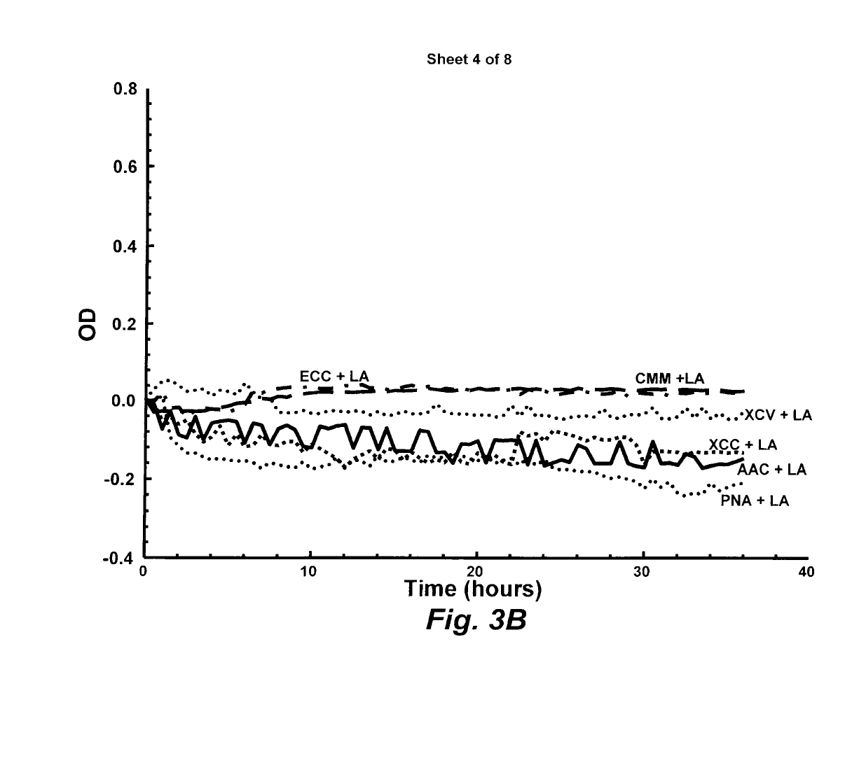

Levulinic acid prevented in vitro growth of all phytopathogenic bacteria screened, as shown in FIGS. 3A and 3B. In the absence of levulinic acid, populations of all six bacteria increased over time, with C. michiganensis subsp. michiganensis increasing the least. In contrast, at concentrations as low as 0.5%, levulinic acid prevented the growth of all bacteria, including the gram-positive species C. michiganensis subsp. michiganensis. Higher concentrations of levulinic acid also limited the in vitro growth of all phytobacteria tested.

### Example 7

### Efficacy of Levulinic Acid as a Seed Treatment for BFB of Watermelon:

To determine the efficacy of levulinic acid and SDS as a seed treatment, watermelon seeds naturally infested with A. avenae subsp. citrulli were soaked or vacuum infiltrated with solutions of 3% levulinic acid and 0.05% SDS, or 0.05% SDS alone as a negative control. Naturally infested seeds were extracted from infected fruits from a BFB outbreak in Colquitt Co., Georgia in the summer of 2009. Seeds (n=100) were treated with levulinic acid by vacuum infiltration or by soaking for 60 minutes. Subsequently, seeds were air-dried and planted. Briefly, samples were planted on two layers of blotter paper (Hoffman Manufacturing Inc.) saturated with sterile water in transparent germination boxes. Seeds were incubated under conditions of 30° C., 100% RH and continuous fluorescent light for 14 days. Each day after planting, seedlings were visually examined and the proportion of seedlings that germinated and developed typical BFB symptoms was enumerated 14 days after planting. This experiment was repeated twice.

### Efficacy of Levulinic Acid as a Seed Treatment for BFB of Watermelon:

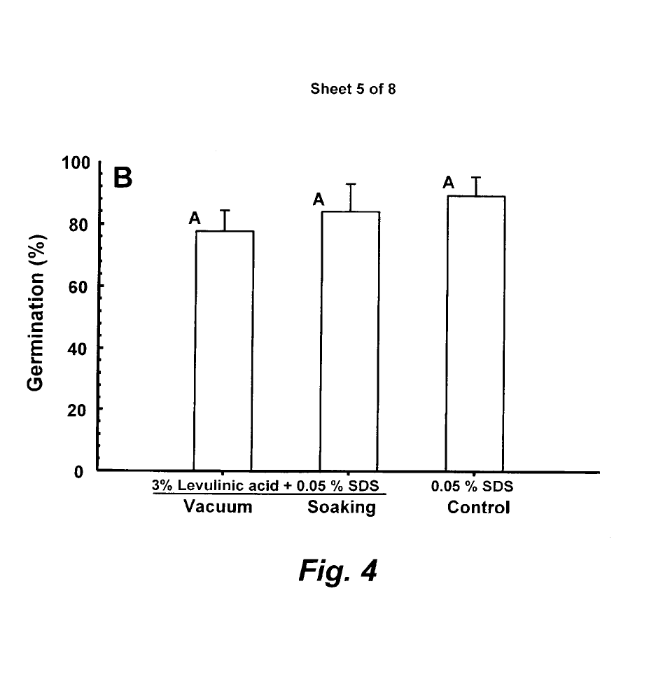

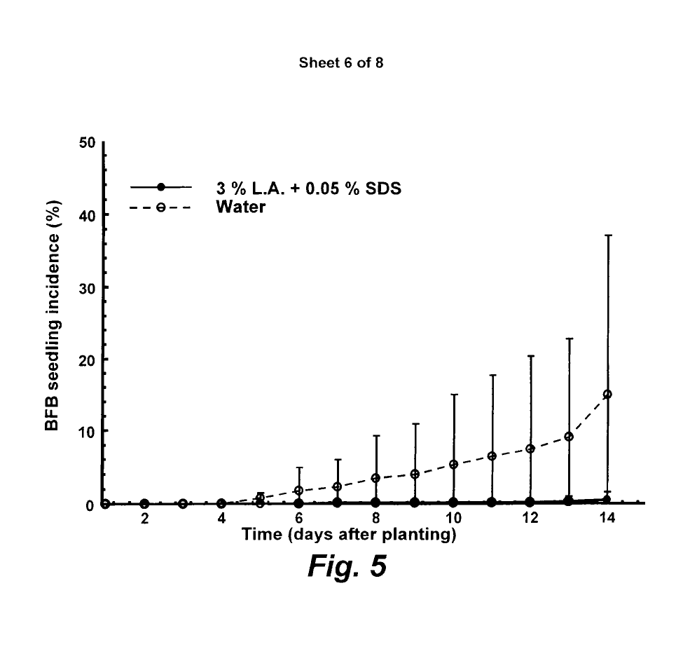

For seedlots naturally infested with A. avenae subsp. citrulli, samples treated with 0.05% SDS (negative control) resulted in BFB seedling transmission percentages that were significantly greater than for seeds treated with levulinic acid. 0.05% SDS alone resulted in a mean BFB seedling transmission percentage of 12.5% (FIG. 4). However, seeds vacuum infiltrated or soaked in 3% levulinic acid with 0.05% SDS resulted in seedlings with less than 1% BFB seedling transmission (FIG. 4). While seed soaking resulted in less BFB seedling transmission than vacuum infiltration, the difference between these two treatment approaches was not statistically significant. Using the same seedlots, we observed that seed treatment with levulinic acid did not have a statistically significant effect on germination percentage of watermelon seeds. Seeds treated with 0.05% SDS displayed the highest mean germination percentage, followed by seeds soaked in 3% levulinic acid for 60 minutes. Seeds vacuum infiltrated with 3% levulinic acid displayed a mean germination percentage of 78% after 14 days (FIG. 4). However, the differences in germination for treated and untreated seeds were not statistically significant. Soaking seeds in levulinic acid for 60 mins was efficacious treatment for limiting BFB seedling transmission without negatively affecting seed germination percentage.

### Example 8

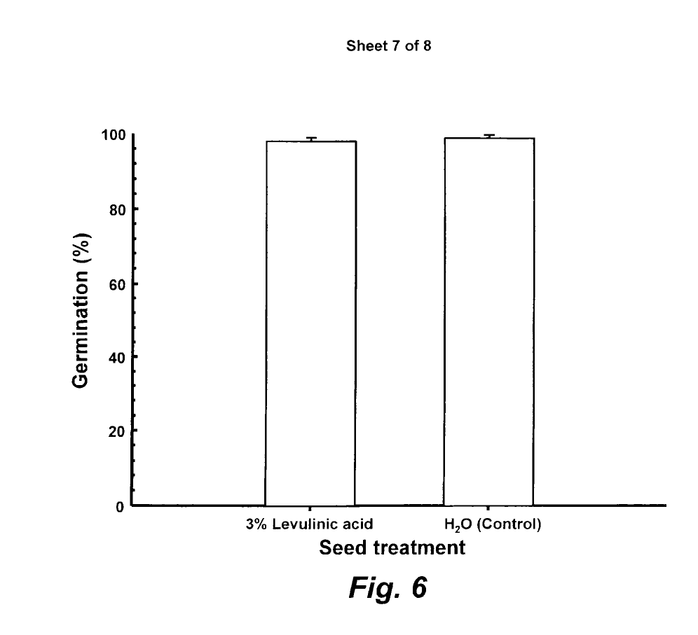

Effect of Seed Treatment with Levulinic Acid on Melon Seedling Physiology:
Melon seeds naturally infested with A. avenae subsp. citrulli were used for this study. Seeds (n=100) were treated by soaking in a solution of 3% levulinic acid and 0.05% SDS or sterile water (negative control) for 60 mins. Subsequently, seeds were air-dried and planted in transparent plastic boxes on saturated blotter paper, as described above. Germination percentage, root length (n=5 plants), shoot length (n=5 plants) and disease incidence (n=100 plants) data were collected each day to determine the effect of seed treatment on seedling physiology and health. This experiment was repeated 2 times.
Effect of Seed Treatments with Levulinic Acid on Melon(Cantaloupe) Seedling Physiology:
As with watermelon seed, seed treatments with levulinic acid reduced BFB seedling transmission for melon (cantaloupe) seeds naturally infested with A. avenae subsp. citrulli. For melon seeds treated with water (negative control), BFB-infected seedlings were observed 5 days after planting (dap) and by 14 dap, mean BFB seedling transmission was 14.76%. In contrast, for seeds treated with 3% levulinic acid and 0.05% SDS, BFB-infected seedlings were not observed until 13 dap and by 14 dap the mean incidence of BFB-infected seedlings was 0.5%. In this study, a 60-minute seed soak with levulinic acid reduced BFB seedling transmission by greater than 97% for naturally infested melon seed. As with watermelon seeds, seed treatments with 3% levulinic acid did not have a significant effect on seed germination relative to the negative control (water), as shown in FIG. 6.

### Example 9

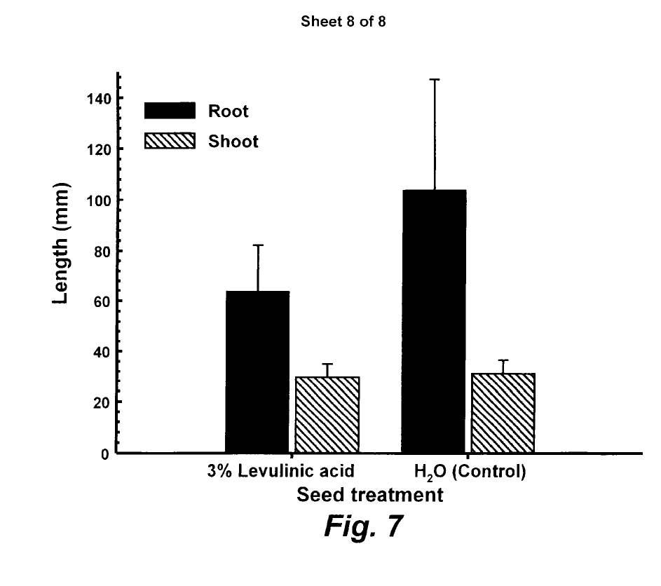

As shown in FIG. 7, there was no noticeable effect of the levulinic acid and SDS seed treatment on mean melon seedling shoot length by 14 dap (29.5 mm) relative to the negative control (31 mm). However, the levulinic acid and SDS seed treatment appeared to limit melon root development. The mean length of roots for seeds treated with levulinic acid was 63.8 mm, relative to the control seeds (104.1 mm). These data suggest that 3% levulinic acid and 0.05% SDS might have an adverse effect on root development even though it does not affect seed germination.

1. A method of reducing the microbial load of a vegetable seed or a sprout thereof, comprising contacting the vegetable seed, or the sprout thereof, with a composition comprising levulinic acid and a detergent for a period suitable for reducing a microbial population of the vegetable seed or the sprout thereof.

2. The method of claim 1, wherein the detergent is sodium dodecyl sulfate (SDS).

3. The method of claim 1, wherein the concentration of levulinic acid in the composition is between about 0.1% wt/vol and about 5% wt/vol levulinic acid.

4. The method of claim 1, wherein the concentration of levulinic acid in the composition is about 3% levulinic acid.

5. The method of claim 1, wherein the concentration of SDS in the composition is between about 0.01% wt/vol and about 0.5% wt/vol SDS.

6. The method of claim 1, wherein the concentration of SDS in the composition is about 0.05% SDS.

7. The method of claim 1, wherein the composition comprises about 3% wt/vol levulinic acid and about 0.05% wt/vol SDS.

8. The method of claim 1 wherein the step of contacting the vegetable seed comprises immersing the vegetable seed or the sprout thereof in the composition.

9. The method of claim 1, wherein the step of contacting the vegetable seed, or the sprout thereof, with the composition comprises contacting the seed with the composition and applying a vacuum thereto, whereby air from the vegetable seed, or the sprout thereof, is replaced with a volume of the composition.

10. The method of claim 1, wherein the composition reduces a microbial population located on the exterior surface of the seed coat (testa) of a vegetable seed, located in or on the seed contents beneath the testa, or located on and beneath the testa of the vegetable seed.

11. The method of claim 1, wherein the composition reduces a microbial population located on the exterior surface of the seed coat (testa) of a vegetable seed, located in or on the seed contents beneath the testa, or located on and beneath the testa of the vegetable seed, and wherein the microbial population is a bacterial population.
